(19) United States
(12) Patent Application Publication
(10) Pub. No.: US 2003/0146202 A1
(43) Pub. Date: Aug. 7, 2003

(54) Lightwave oven with radiant lamps of different color temperature

(76) Inventors: Martina Backer, Traunreut (DE); Wolfgang Fuchs, Altenmarkt A.D.ALZ (DE); Bernhard Herold, Regensburg (DE); Katrin Horn, Traunreut (DE); Kurt Lintner, Nussdorf (DE); Andreas Nitschke, Tacherting (DE); Martin Schulte, Hagen (DE); Martin Thaler, Oberteisendorf (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/354,778

(22) Filed: Jan. 30, 2003

(30) Foreign Application Priority Data
Jan. 30, 2002 (DE) 102 03 610.1

(51) Int. Cl. F27D 11/00

(52) U.S. Cl. 219/405; 219/411

(57) ABSTRACT

A lightwave oven having a cooking chamber and at least one lightwave heating device for heating food in the cooking chamber, and at least one reflector for reflecting the lightwaves produced by the lightwave heating device in the direction of the food and improve thorough cooking and browning of the food. In addition to the radiant lamps of high color temperature, separate radiant lamps of low color temperature are provided to also improve browning of the food. In each case, two radiant lamps of different color temperature can be fixed to a common holder, the holder being held on a movement device such that it can be pivoted, and the radiant lamps radiating light in different directions.

### BACKGROUND OF THE INVENTION

Field of the Invention

The invention relates to a lightwave oven having a cooking chamber and at least one lightwave heating device for heating food in the cooking chamber, and having at least one reflector for reflecting the lightwaves produced by the lightwave heating device in the direction of the food.

Lightwave ovens are ovens that heat the food by visible and infrared radiation. As a result of the action of visible, almost visible, and infrared radiation of high intensity on the food, a very rapid and high-quality cooking and baking method is provided. The cooking times are approximately of the time frame that is known from the use of microwave ovens, browning being obtained as is known from conventional ovens.

A lightwave oven of the generic type is known, for example, from International publication WO 00/40912 A1, corresponding to U.S. Pat. No. 6,417,494 to Westerberg et al. In the case of this prior art lightwave oven, an upper translucent top wall and a lower translucent bottom wall bound the cooking chamber. Above the translucent top wall, an upper lightwave heating device is disposed such that it can be moved to and fro in an upper duct separated from the cooking chamber. Underneath the translucent bottom wall, a lower lightwave heating device is disposed such that it can be moved to and fro in a lower duct separated from the cooking chamber. The light/radiation sources used in the known lightwave ovens are tungsten quartz halogen lamps, such as quartz arc lamps.

### SUMMARY OF THE INVENTION

It is accordingly an object of the invention to provide a lightwave oven with radiant lamps of different color temperature that overcomes the hereinafore-mentioned disadvantages of the heretofore-known devices of this general type and that improves thorough cooking and browning of the food.

With the foregoing and other objects in view, there is provided, in accordance with the invention, a lightwave oven, including a cooking chamber and at least one lightwave heating device producing lightwaves for heating food in the cooking chamber, the at least one lightwave heating device having at least one reflector reflecting the lightwaves in a direction of the food and at least two radiant lamps differing in color temperature.

The level of browning and the thorough cooking time for the food depend substantially on the power of the radiation source and on the color temperature, that is to say, on the spectrum of the light emitted by the radiation source. For thorough cooking of food, a high penetration depth of the light radiation is desirable. For browning, a high power density at the surface of the food is important.

Longwave light is, therefore, more beneficial to browning. On the other hand, shortwave light with high radiation intensity is better for thorough cooking. It is, therefore, advantageous if the lightwave heating device is optimized firstly with regards to browning and secondly with regards to thorough cooking.

The lightwave heating device according to the invention includes at least two radiant lamps that differ in their color temperature.

This is because it has been shown that a lightwave heating device that contains only radiant lamps of the same color temperature cannot be optimized with regard to browning and thorough cooking but can always be optimized only with regard to one of these objectives. For example, use is normally made of halogen lamps with a color temperature of about 3000 to 2300 K, which emit shortwave light and are particularly beneficial for thorough cooking. If the food is, then, to be browned, the power of the halogen lamps must be reduced by reducing the voltage applied such that light with a low color temperature of about 1300 K to 1000 K is emitted in a longwave range. At reduced voltage, however, light is, then, emitted only with a very low power. It is therefore a very long time until the desired level of browning is achieved.

In accordance with another feature of the invention, in addition to the radiant lamps of high color temperature, separate radiant lamps of low color temperature are provided so that the browning of the food is also improved.

Trials have shown that it is advantageous if at least one radiant lamp has a color temperature of between 3200 K and 2000 K, preferably, between 3000 K and 2300 K, and at least one radiant lamp has a color temperature between 1700 K and 800 K, preferably, between 1300 K and 1000 K.

Uniform browning of the surface of the food is achieved if the radiant lamps are fixed to a movement device in the lightwave oven and, as a result, the radiant lamps can be moved over the food. As a result, the lightwaves emitted are distributed uniformly over the surface of the food. In the same way, it is also expedient to fix the radiant lamps for thorough cooking to a movement device.

In a simple way, a movement device can be implemented in which the radiant lamps can be moved to and fro on a straight path within the lightwave oven, between a first position and a second position. The radiant lamps of different color temperature can be fixed to separate movement devices so that the radiant lamps of different color temperature can be operated independently of one another.

It is more cost-effective if the radiant lamps of different color temperature are fixed to a common movement device. The radiant lamps can, advantageously, be fixed to the common movement device such that they execute a joint movement with respect to the food.

If it is not required that the radiant lamps of different color temperature be in operation at the same time, or if the intention is to avoid the radiant lamps of different color temperature being in operation at the same time, a particularly beneficial variant can be implemented in which, for example, in each case two radiant lamps of different color temperature are fixed to a common holder, the holder is held on the movement device such that it can be pivoted and/or the radiant lamps radiate in different directions. In one variant, the two radiant lamps of different color temperature are fixed to a pivotable holder such that they radiate in opposite directions. As a result of the holder being pivoted through 180°, either one or the other radiant lamp irradiates the food.

Given a combination of such a pivotable holder with a movement device that can be moved to and fro in the lightwave oven, it is advantageous to pivot the holder in the turning positions of the movement device, that is to say, in the first position and/or in the second position. The holder can be pivoted by an electric motor, in particular, a stepping motor. As a result, driving or selecting the respectively needed radiant lamps can be regulated electrically or electronically, in particular, based upon a predefined cooking program.

It may, optionally, be expedient to equip the radiant lamps of different color temperature with reflectors of different geometry. A reflector that has an elliptical curve as generatrix is used, in particular, to concentrate the light emitted by the associated radiant lamp onto a focus. At the focus, the light energy emitted is concentrated onto a small area. It is, therefore, in particular, expedient to equip a radiant lamp of low color temperature, which is optimized for browning the food, with a reflector that additionally concentrates the light energy. As a result, faster and more intensive browning is achieved. A radiant lamp of low color temperature should, therefore, be combined, in particular, with a reflector whose geometry is formed from a generatrix that is an elliptical curve.

For thorough cooking, it is desirable for the deeply penetrating light energy to be distributed as uniformly as possible in the food so that the food is cooked to the same extent at all its internal points. A reflector that has a parabolic curve as generatrix is used, in particular, to output the light emitted by the associated radiant lamp in parallel beams. The light energy emitted is, therefore, not concentrated onto a small area but distributed very uniformly over a large area. It is, therefore, in particular, expedient to equip a radiant lamp of high color temperature, which is optimized for thorough cooking of the food, with a reflector that distributes the light energy very uniformly, which means that uniform thorough cooking of the food is achieved. A radiant lamp of high color temperature should, therefore, be combined, in particular, with a reflector whose geometry is formed from a generatrix that is a parabolic curve.

In accordance with a further feature of the invention, one of the radiant lamps having the at least another lamp reflector with the geometry formed from a generatrix with a parabolic curve section has a color temperature between approximately 3200 K and approximately 2000 K, in particular, between 3000 K and 2300 K.

In accordance with an added feature of the invention, one of the radiant lamps having the at least one lamp reflector with the geometry formed from a generatrix with an elliptical curve section has a color temperature between approximately 1700 K and approximately 800 K, preferably, the color temperature is between 1300 K and 1000 K.

In accordance with an additional feature of the invention, the one radiant lamp is a halogen lamp and the other radiant lamp is a quartz spotlight.

In accordance with yet another feature of the invention, the at least two radiant lamps differing in color temperature alternate in operation.

With the objects of the invention in view, there is also provided a lightwave oven, including a cooking chamber and at least two lightwave heating devices for heating food in the cooking chamber, each of the at least two lightwave heating devices having at least two radiant lamps producing lightwaves differing in color temperature and at least two reflectors reflecting the lightwaves of a respective one of the at least two radiant lamps in a direction of the food.

With the objects of the invention in view, there is also provided a lightwave oven, including a cooking chamber having sides, at least two movement devices each moving to and fro at different ones of the sides of the cooking chamber between a first position and a second position, at least two lightwave heating devices for heating food in the cooking chamber, each of the at least two lightwave heating devices having at least two radiant lamps producing lightwaves differing in color temperature and being pivotally fixed to a respective one of the at least two movement devices for moving and pivoting the at least two radiant lamps with respect to the food, at least a first of the at least two radiant lamps having a color temperature between approximately 3200 K and approximately 2000 K and at least a second of the at least two radiant lamps having a color temperature between approximately 1700 K and approximately 800 K, and at least two reflectors reflecting the lightwaves of a respective one of the at least two radiant lamps in a direction of the food.

In accordance with a concomitant feature of the invention, one of the at least two radiant lamps with the color temperature between approximately 3200 K and approximately 2000 K has a lamp reflector with a geometry formed from a generatrix with a parabolic curve section and another of the at least two radiant lamps with the color temperature between approximately 1700 K and approximately 800 K has a lamp reflector with a geometry formed from a generatrix with an elliptical curve section.

Other features that are considered as characteristic for the invention are set forth in the appended claims.

Although the invention is illustrated and described herein as embodied in a lightwave oven with radiant lamps of different color temperature, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a perspective view from above an oven housing of a lightwave oven according to the invention with a lightwave heating device that can be moved to and fro;

FIG. 2 is a diagrammatic cross-sectional view through the lightwave oven of FIG. 1;

FIG. 3 is a diagrammatic cross-sectional view through the lightwave oven of FIG. 1 with pivotable holders; and

FIG. 4 is a graph illustrating radiant lamps of different color temperatures.

### DESCRIPTION OF THE PREFERRED EMBODIMENTS

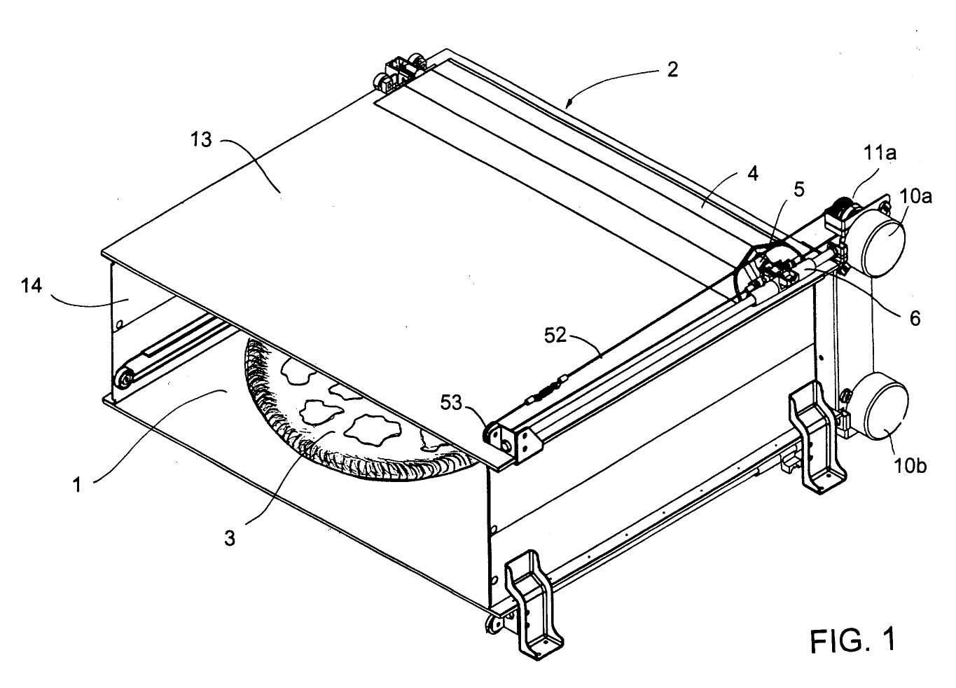

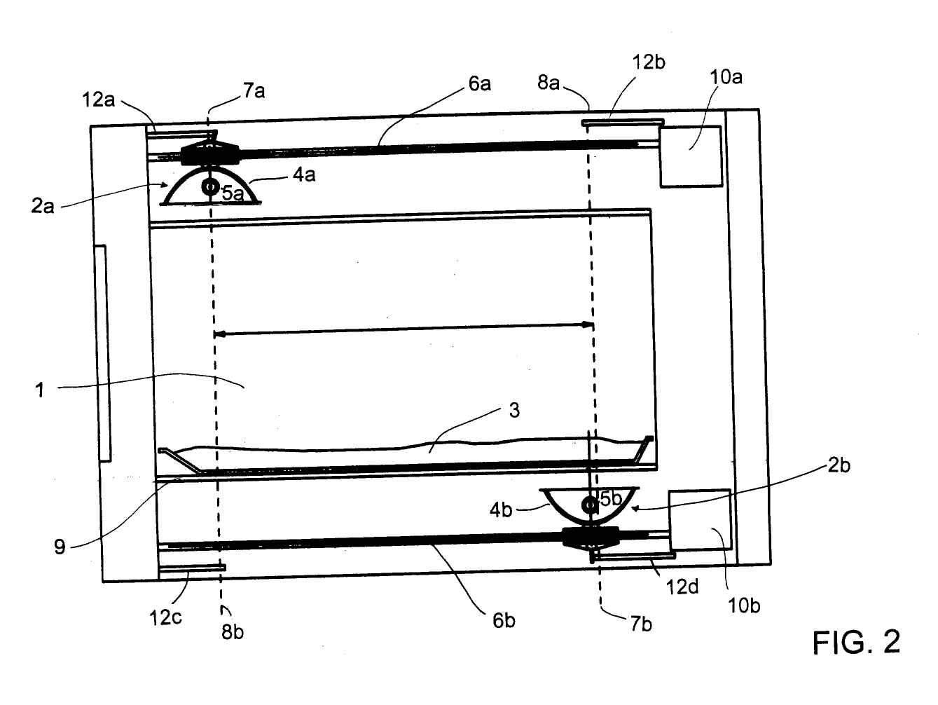

Referring now to the figures of the drawings in detail and first, particularly to FIG. 1 thereof, there is shown a configuration of a lightwave oven with a lightwave heating device that can be moved to and fro. The cooking chamber 1 is enclosed by the oven housing 13 and, at its front side, has an opening 14 for food 3 to be put into the cooking chamber 1. Above the cooking chamber 1 and underneath the cooking chamber 1, a lightwave heating device 2 that can be moved to and fro is disposed in each case. The lightwave heating device 2a disposed above the cooking chamber 1 (see FIG. 2) includes an upper radiant lamp 5a and an upper lamp reflector 4a. The lightwave heating device 2b disposed underneath the cooking chamber 1 includes a lower radiant lamp 5b and a lower lamp reflector 4b. Each lightwave heating device 2, 2a, 2b is fixed to its own movement device 6, 6a, 6b such that it can be moved to and fro. The upper movement device 6a is driven through a pull cable 52 and a deflection roller 53 and an upper gear mechanism 11a by the stepping motor 10a. The lower movement device 6b is driven in the same way as the upper movement device 6a but independently of the latter by the lower stepping motor 10b.

The schematic cross-section through the lightwave oven, illustrated schematically in FIG. 2, shows the cooking chamber 1 with the food 3 placed on the food support 9. The upper lightwave heating device 2a includes the radiant lamp 5a and the lamp reflector 4a. The lower lightwave heating device 2b includes the radiant lamp 5b and the lamp reflector 4b. The upper lightwave heating device 2a can be moved to and fro on a travel path from a first position 7a into a second position 8a by the movement device 6a. The movement device 6a is driven by the stepping motor 10a. The lower lightwave heating device 2b can be moved to and fro on a travel path from a first position 7b into a second position 8b by the movement device 6b. The movement device 6b is driven through the stepping motor 10b. A limit switch 12a provides a signal for reversing the movement of the upper lightwave heating device 2a in the first position 7a. A limit switch 12b provides a signal for reversing the movement of the upper lightwave heating device 2a in the second position 8a. A limit switch 12c provides a signal for reversing the movement of the lower lightwave heating device 2b in the second position 8b. A limit switch 12d provides a signal for reversing the movement of the lower lightwave heating device 2b in the first position 7b.

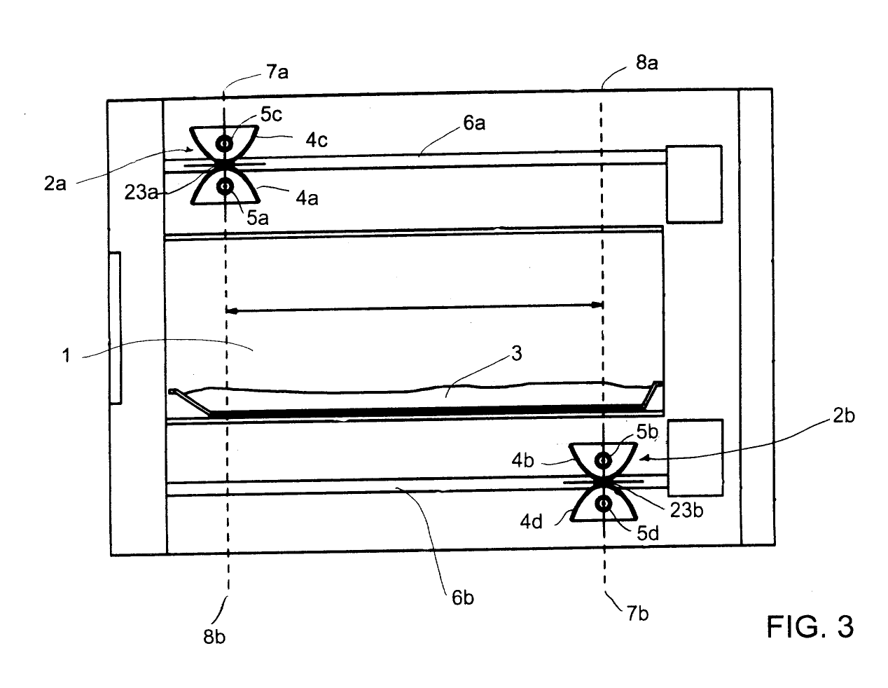

In FIG. 3, the lightwave oven is illustrated with pivotable holders 23a, 23b. The upper lightwave heating device 2a is mounted on the movement device 6a such that it can be moved to and fro. The holder 23a can be pivoted through 180° so that either the rod-like or rod-shaped radiant lamp 5a of high color temperature or the rod-shaped radiant lamp 5c of low color temperature radiates downward in the direction of the food 3. The rod-shaped radiant lamp 5a of high color temperature is surrounded by the channel-like lamp reflector 4a. The lamp reflector 4a has a geometry that is formed from a generatrix with a parabolic curve. In the view shown, the radiant lamp 5a is ready to operate. The radiant lamp 5c is out of operation in the view shown. The radiant lamp 5c of low color temperature is surrounded by the channel-like lamp reflector 4c. The lamp reflector 4c has a geometry that is formed from a generatrix with an elliptical curve.

The lower lightwave heating device 2b is mounted on the movement device 6b such that it can be moved to and fro. The holder 23b can be pivoted through 180° so that either the rod-shaped radiant lamp 5b of high color temperature or the rod-shaped radiant lamp 5d of low color temperature radiates upward in the direction of the food 3. The rod-shaped radiant lamp 5b of high color temperature is surrounded by the channel-like lamp reflector 4b. The lamp reflector 4b has a geometry that is formed from a generatrix with a parabolic curve. In the view shown, the radiant lamp 5b is ready to operate. The radiant lamp 5d is out of operation in the view shown. The radiant lamp 5d of low color temperature is surrounded by the channel-like lamp reflector 4d. The lamp reflector 4d has a geometry that is formed from a generatrix with an elliptical curve.

Overall, the lightwave oven is in thorough cooking operation in the view shown and the lightwave heating devices 5c and 5d for browning are not switched on and are, therefore, out of operation.

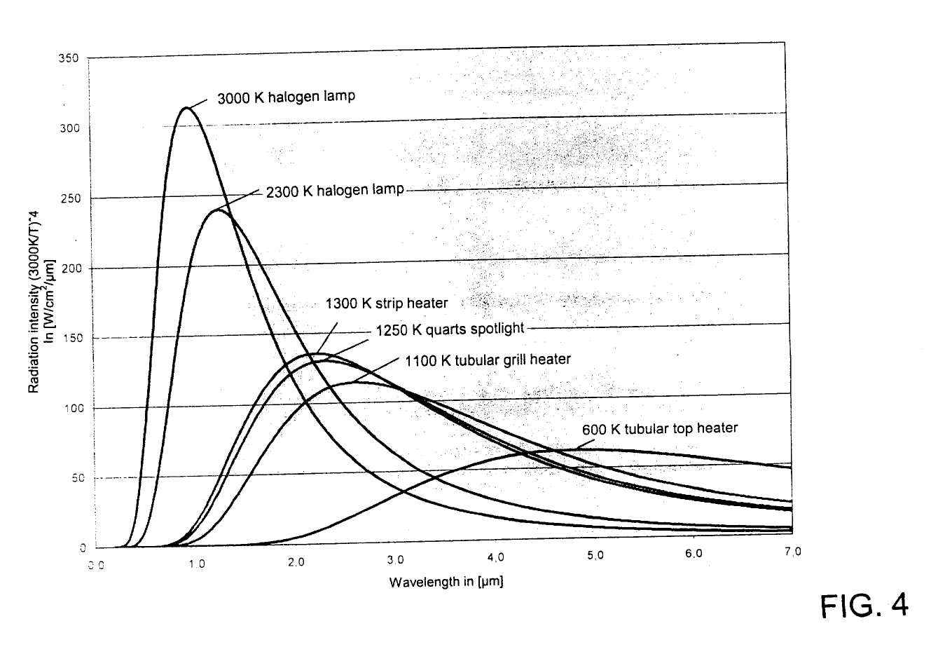

The graph of radiant lamps of different color temperature, illustrated in FIG. 4, shows the significance of the color temperature of different types of radiant lamps. Each type of radiant lamp has an inherent radiation distribution with its own spectrum of wavelengths of the emitted light. The radiation intensity in W/cm²/μm is plotted on the ordinate, and the wavelength in μm on the abscissa. From left to right, the graph shows a halogen lamp at a color temperature of 3000 K, a halogen lamp at a color temperature of 2300 K, a strip heater at a color temperature of 1300 K, a quartz spotlight at a color temperature of 1250 K, a tubular grill heater at a color temperature of 1100 K, and a tubular top heater at a color temperature of 600 K.

Depending on the oven characteristics and/or depending on the food, it may be expedient to combine one or more different types of radiant lamps of different color temperature in the lightwave oven according to the invention.

We claim:

1. A lightwave oven, comprising:
a cooking chamber; and
at least one lightwave heating device producing lightwaves for heating food in said cooking chamber, said at least one lightwave heating device having:
at least one reflector reflecting the lightwaves in a direction of the food; and
at least two radiant lamps differing in color temperature.

2. The lightwave oven according to claim 1, wherein:
at least a first of said at least two radiant lamps has a color temperature between approximately 3200 K and approximately 2000 K; and
at least a second of said at least two radiant lamps has a color temperature between approximately 1700 K and approximately 800 K.

3. The lightwave oven according to claim 1, wherein:
at least a first of said at least two radiant lamps has a color temperature between approximately 3000 K and approximately 2300 K; and
at least a second of said at least two radiant lamps has a color temperature between approximately 1300 K and approximately 1000 K.

4. The lightwave oven according to claim 1, including at least one movement device moving at said cooking chamber with respect to the food, said at least two radiant lamps being fixed to said at least one movement device for moving said at least two radiant lamps with respect to the food.

5. The lightwave oven according to claim 4, wherein said at least one movement device moves to and fro in said cooking chamber between a first position and a second position.

6. The lightwave oven according to claim 1, including movement devices moving at said cooking chamber with respect to the food, each of said at least two radiant lamps being fixed to a respective one of said movement devices for moving said at least two radiant lamps with respect to the food.

7. The lightwave oven according to claim 1, including:
movement devices each moving to and fro in said cooking chamber between a first position and a second position;
a plurality of said at least two radiant lamps being fixed to a common one of said movement devices; and
said common movement device commonly moving said plurality of radiant lamps with respect to the food.

8. The lightwave oven according to claim 7, wherein:
said at least two radiant lamps is a number of radiant lamps; and
common holders respectively fix two of said number of radiant lamps to each of said movement devices.

9. The lightwave oven according to claim 8, wherein each of said two radiant lamps at each of said movement devices radiate in different directions.

10. The lightwave oven according to claim 9, wherein each of said common holders is pivotally connected to a respective one of said movement devices.

11. The lightwave oven according to claim 10, wherein:
each of said two radiant lamps at each of said movement devices radiate in opposite directions; and
each of said common holders pivots through 180°.

12. The lightwave oven according to claim 11, wherein each of said common holders pivots in at least one of said first position and said second position.

13. The lightwave oven according to claim 11, wherein each of said common holders pivots at said first position and at said second position.

14. The lightwave oven according to claim 10, including an electric motor connected to at least one of said common holders and pivoting said at least one common holder.

15. The lightwave oven according to claim 14, wherein said electric motor is a stepping motor.

16. The lightwave oven according to claim 10, including electric motors connected to each of said common holders and pivoting a respective one of said common holders.

17. The lightwave oven according to claim 16, wherein said electric motors are stepping motors.

18. The lightwave oven according to claim 1, wherein:
said at least two radiant lamps have lamp reflectors; and
at least one of said lamp reflectors differs in geometry from at least another one of said lamp reflectors.

19. The lightwave oven according to claim 18, wherein:
a geometry of said at least one lamp reflector is formed from a generatrix with an elliptical curve section; and
a geometry of said at least another lamp reflector is formed from a generatrix with a parabolic curve section.

20. The lightwave oven according to claim 19, wherein one of said radiant lamps having said at least another lamp reflector with said geometry formed from a generatrix with a parabolic curve section has a color temperature between approximately 3200 K and approximately 2000 K.

21. The lightwave oven according to claim 20, wherein said color temperature is between approximately 3000 K and approximately 2300 K.

22. The lightwave oven according to claim 20, wherein said one radiant lamp is a halogen lamp.

23. The lightwave oven according to claim 20, wherein said at least two radiant lamps are halogen lamps.

24. The lightwave oven according to claim 19, wherein one of said radiant lamps having said at least one lamp reflector with said geometry formed from a generatrix with an elliptical curve section has a color temperature between approximately 1700 K and approximately 800 K.

25. The lightwave oven according to claim 24, wherein said color temperature is between approximately 1300 K and approximately 1000 K.

26. The lightwave oven according to claim 24, wherein said one radiant lamp is a quartz spotlight.

27. The lightwave oven according to claim 24, wherein said at least two radiant lamps are quartz spotlights.

28. The lightwave oven according to claim 20, wherein another of said radiant lamps having said at least one lamp reflector with said geometry formed from a generatrix with an elliptical curve section has a color temperature between approximately 1700 K and approximately 800 K.

29. The lightwave oven according to claim 28, wherein:
said one radiant lamp is a halogen lamp; and
said another radiant lamp is a quartz spotlight.

30. The lightwave oven according to claim 28, wherein said one radiant lamp and said another radiant lamp alternate in operation.

31. The lightwave oven according to claim 1, wherein said at least two radiant lamps differing in color temperature alternate in operation.

32. A lightwave oven, comprising:
a cooking chamber; and
at least two lightwave heating devices for heating food in said cooking chamber, each of said at least two lightwave heating devices having:
at least two radiant lamps producing lightwaves differing in color temperature; and
at least two reflectors reflecting the lightwaves of a respective one of said at least two radiant lamps in a direction of the food.

33. A lightwave oven, comprising:
a cooking chamber having sides;
at least two movement devices each moving to and fro at different ones of said sides of said cooking chamber between a first position and a second position;
at least two lightwave heating devices for heating food in said cooking chamber, each of said at least two lightwave heating devices having:
at least two radiant lamps producing lightwaves differing in color temperature and being pivotally fixed to a respective one of said at least two movement devices for moving and pivoting said at least two radiant lamps with respect to the food, at least a first of said at least two radiant lamps having a color temperature between approximately 3200 K and approximately 2000 K and at least a second of said at least two radiant lamps having a color temperature between approximately 1700 K and approximately 800 K; and
at least two reflectors reflecting the lightwaves of a respective one of said at least two radiant lamps in a direction of the food.

34. The lightwave oven according to claim 33, wherein:
one of said at least two radiant lamps with said color temperature between approximately 3200 K and approximately 2000 K has a lamp reflector with a geometry formed from a generatrix with a parabolic curve section; and
another of said at least two radiant lamps with said color temperature between approximately 1700 K and approximately 800 K has a lamp reflector with a geometry formed from a generatrix with an elliptical curve section.
